(19) United States
(12) Patent Application Publication
(10) Pub. No.: US 2016/0341081 A1
(43) Pub. Date: Nov. 24, 2016

(54) LUBRICANT FEED MECHANISM

(71) Applicant: TAIHO KOGYO CO., LTD., Toyota-shi (JP)

(72) Inventors: Kenichiro TAKAMA, Toyota-shi (JP); Satoru KANBARA, Toyota-shi (JP); Toshiki KUROKI, Toyota-shi (JP)

(73) Assignee: Taiho Kogyo Co., Ltd., Toyota-shi (JP)

(21) Appl. No.: 15/112,874

(22) PCT Filed: Mar. 9, 2015
(86) PCT No.: PCT/JP2015/056805

§ 371 Date: Jul. 20, 2016

(30) Foreign Application Priority Data
Mar. 14, 2014 (JP) 2014-051540

(51) Int. Cl. F01M 1/12; F01M 1/10; F02B 39/14; F01M 1/02

(52) U.S. Cl. CPC F01M 1/12; F01M 1/02; F01M 1/10; F02B 39/14; F01M 2001/0215; F01M 2001/123

(57) ABSTRACT

There is provided a lubricant feed mechanism capable of improving the mechanical efficiency of a supercharger. A lubricant feed mechanism for feeding lubricants to an engine and a supercharger mounted on the engine includes a block-side oil passage for feeding the lubricant to a cylinder block of the engine, a block-side oil pan that is disposed in a path of the block-side oil passage and stores the lubricant flowing through the block-side oil passage, a head-side oil passage for feeding the lubricant to the supercharger, and a head-side oil pan that is disposed in a path of the head-side oil passage and stores the lubricant flowing through the head-side oil passage, the block-side oil passage and the head-side oil passage being configured to be independent of each other.

### TECHNICAL FIELD

The present invention relates to a lubricant feed mechanism for feeding lubricant to an engine and a supercharger mounted on the engine.

### BACKGROUND ART

An engine and a supercharger mounted on the engine are conventionally fed with lubricant, for example, from an oil pan attached to the engine (for example, see Patent Literature 1).

According to a technique disclosed in Patent Literature 1, a main oil pump that is driven by power transmitted from an engine feeds lubricant to the engine and a supercharger. According to the technique disclosed in Patent Literature 1, an auxiliary oil pump is driven when an amount of lubricant fed by the main oil pump is not sufficient (for example, when the viscosity of lubricant is increased, for example, due to operation conditions, and as a result, a greater than normal amount of lubricant is required).

Thus, according to the technique disclosed in Patent Literature 1, the auxiliary oil pump makes up for the shortfall in the lubricant fed from the main oil pump.

Here, feeding lubricant to the engine will cause the lubricant to contain excessive sludge.

The technique disclosed in Patent Literature 1 is configured to return the lubricant fed to the engine and the supercharger to the original oil pan, and this results in feeding of lubricant containing excessive sludge to the supercharger.

In this case, bearings supporting a turbine shaft of the supercharger may not be effectively lubricated. Accordingly, the technique disclosed in Patent Literature 1 may not improve the mechanical efficiency of a supercharger.

### CITATION LIST

### Patent Literature

Patent Literature 1: JP 2006-83782 A

### SUMMARY OF INVENTION

### Technical Problem

The present invention, which has been made in view of the foregoing disadvantages, provides a lubricant feed mechanism capable of improving the mechanical efficiency of a supercharger.

### Solution to Problem

A lubricant feed mechanism of the present invention for feeding lubricant to an engine and a supercharger mounted on the engine includes a first oil passage for feeding lubricant to a cylinder block of the engine, a first oil pan that is disposed in a path of the first oil passage and stores the lubricant flowing through the first oil passage, a second oil passage for feeding lubricant to the supercharger, and a second oil pan that is disposed in a path of the second oil passage and stores the lubricant flowing through the second oil passage, the first oil passage and the second oil passage being configured to be independent of each other.

The lubricant feed mechanism of the present invention further includes an electrically driven oil pump that is disposed in a state of being immersed in the lubricant stored in the second oil pan and pumps the lubricant stored in the second oil pan.

In the lubricant feed mechanism of the present invention, the second oil passage is provided to feed the lubricant stored in the second oil pan to a cylinder head of the engine.

In the lubricant feed mechanism of the present invention, the second oil pan is disposed below the supercharger.

### Advantageous Effects of Invention

The present invention has the following effects.

The lubricant feed mechanism of the present invention can improve the mechanical efficiency of the supercharger.

The lubricant feed mechanism of the present invention can effectively improve the mechanical efficiency of the supercharger.

The lubricant feed mechanism of the present invention can improve the mechanical efficiency of a member disposed in the cylinder head.

The lubricant feed mechanism of the present invention can efficiently circulate lubricant.

### BRIEF DESCRIPTION OF DRAWINGS

FIG. 1 is a schematic diagram showing a configuration of a lubricant feed mechanism according to an embodiment of the present invention.

FIG. 2 is a schematic diagram showing lubricant fed to a supercharger.

FIG. 3 is a schematic diagram showing another embodiment of the lubricant feed mechanism.

### DESCRIPTION OF EMBODIMENTS

A lubricant feed mechanism 1 according to an embodiment of the present invention is described below.

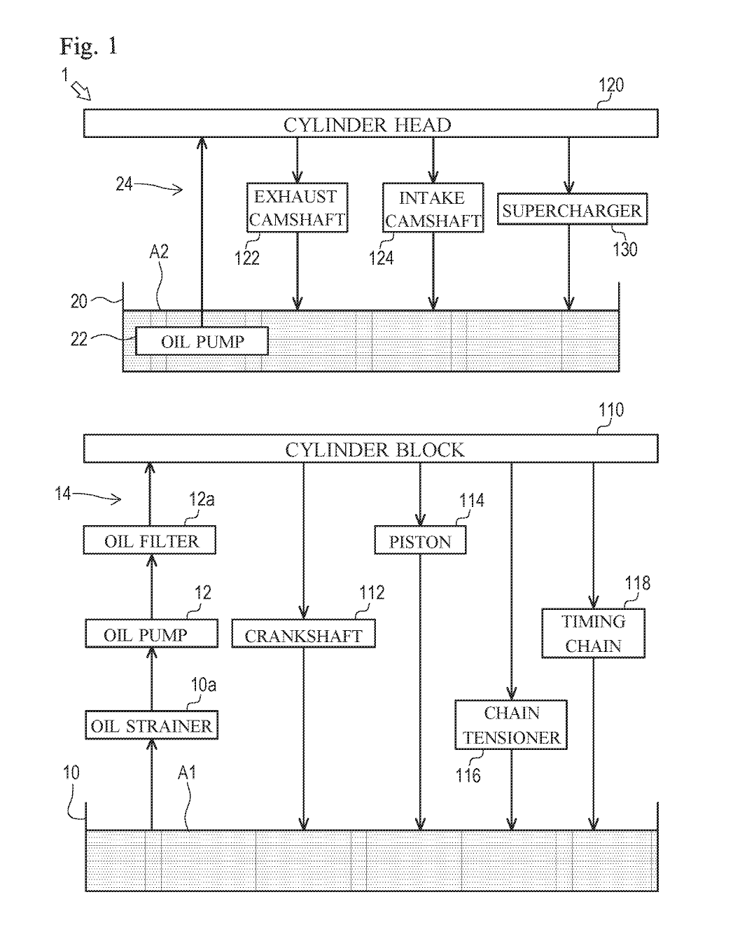

As shown in FIG. 1, an engine according to this embodiment includes a cylinder block 110, a cylinder head 120, and the like. A supercharger 130 is mounted on one side of the cylinder head 120 of the engine.

The engine is mounted, for example, on a vehicle such as an automobile. The cylinder block 110 is provided with a crankshaft 112, a piston 114, and the like. The cylinder head 120 is provided with an exhaust camshaft 122, an intake camshaft 124, and the like.

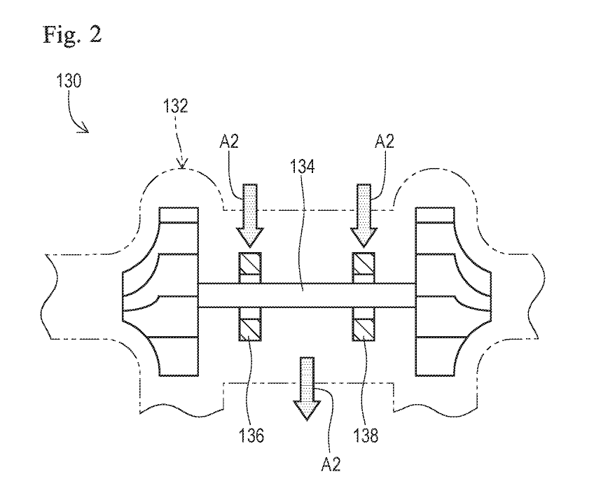

The supercharger 130 is intended to increase a pressure of the intake air to the engine. The supercharger 130 according to the embodiment compresses air using the exhaust gas from the engine and sends the compressed air into the engine. The supercharger 130 is a turbocharger and includes a turbine shaft 134, two bearings 136 and 138 supporting the intermediate portion of the turbine shaft 134, and wheels supported at both ends of the turbine shaft 134, which are disposed in a housing 132 (see FIG. 2).

Note that the type of the supercharger is not limited to the embodiment and it can be, for example, a mechanical supercharger that is driven by power transmitted from an engine.

The lubricant feed mechanism 1 feeds lubricants A1 and A2 to such an engine (the cylinder block 110 and the cylinder head 120) and the supercharger 130.

The lubricant feed mechanism 1 includes a block-side oil pan 10, a block-side oil pump 12, a block-side oil passage 14, a head-side oil pan 20, a head-side oil pump 22, a head-side oil passage 24, and the like.

The block-side oil pan 10 is attached below the cylinder block 110. The block-side oil pan 10 stores the lubricant A1.

The block-side oil pump 12 is disposed in the cylinder block 110 of the engine. The block-side oil pump 12 is composed, for example, of a Trochoid (registered trademark) pump that is connected, for example, to the crankshaft 112 of the engine and is driven by rotation of the crankshaft 112. In other words, the block-side oil pump 12 is driven by the engine at a rotational speed corresponding to the rotational speed of the engine.

The block-side oil pump 12 has a relief valve (not shown) therein that returns the lubricant A1 from the discharge side of the block-side oil pump 12 to the suction side based on the discharge pressure of the block-side oil pump 12.

The block-side oil pump 12 communicates with the block-side oil pan 10 through an oil strainer 10a, pipes, and the like. The block-side oil pump 12, being driven by the engine, sucks the lubricant A1 from the block-side oil pan 10 and pumps the lubricant A1 toward the crankshaft 112, and the like of the cylinder block 110.

The lubricant A1 pumped by the block-side oil pump 12 is fed to a main oil hole (not shown) formed in the cylinder block 110 through an oil filter 12a. The oil filter 12a is provided with a relief valve (not shown) for circulating the lubricant A1 when the oil filter 12a is clogged.

The lubricant A1 fed to the main oil hole of the cylinder block 110 is branched and fed to members disposed in the cylinder block 110, such as, for example, the crankshaft 112, the piston 114, a chain tensioner 116, and a timing chain 118.

That is, the cylinder block 110 is provided with a plurality of passages divergently extending from the main oil hole toward the crankshaft 112, the piston 114, and the like. The lubricant A1 is fed to the cylinder block 110 through the passages.

The lubricant A1 is collected in the block-side oil pan 10 after being fed to the cylinder block 110.

That is, the cylinder block 110 is provided with an oil outlet port (not shown) serving as a passage that extends from below the crankshaft 112, the piston 114, and the like, toward the block-side oil pan 10 and is open above the block-side oil pan 10. The lubricant A1 is collected in the block-side oil pan 10 through the oil outlet port.

The block-side oil passage 14 is a path of the lubricant A1, through which the lubricant A1 is fed from the block-side oil pan 10 to the crankshaft 112, the piston 114, and the like of the cylinder block 110 and is then collected in the block-side oil pan 10.

In other words, the block-side oil passage 14 according to the embodiment includes pipes communicating with the block-side oil pump 12 and the oil strainer 10a, the main oil hole of the cylinder block 110, the passages formed in the cylinder block 110, the oil outlet port, and the like.

In this manner, the block-side oil passage 14 according to the embodiment serves as a first oil passage for feeding the lubricant A1 to the cylinder block 110 of the engine.

The block-side oil pan 10 according to the embodiment serves as a first oil pan that is disposed in the path of the block-side oil passage 14 and stores the lubricant A1 flowing through the block-side oil passage 14.

The head-side oil pan 20 is attached, for example, to the same side as the side on which the supercharger 130 of the engine is mounted and is disposed below the supercharger 130. That is, the head-side oil pan 20 is attached to the one side of the cylinder head 120 of the engine. The head-side oil pan 20 stores the lubricant A2.

The head-side oil pump 22 is composed of a commercially available electrically driven pump. The head-side oil pump 22 is electrically connected, for example, to an engine control unit (ECU) and a battery (not shown) mounted on a vehicle and is driven by application of a voltage from the battery in response to an electrical signal from the ECU.

The head-side oil pump 22 according to the embodiment is disposed inside the head-side oil pan 20 and, more specifically, is disposed in a state of being immersed in the lubricant A2 in the head-side oil pan 20. The head-side oil pump 22 communicates with an oil hole (not shown) formed in the cylinder head 120 through a pipe, and the like.

The head-side oil pump 22, being driven by the engine, pumps the lubricant A2 from the head-side oil pan 20 toward the cylinder head 120.

In other words, the head-side oil pump 22 according to the embodiment serves as an oil pump for pumping the lubricant A2 stored in the head-side oil pan 20.

The lubricant A2 pumped by the head-side oil pump 22 is branched and fed to members disposed in the cylinder head 120, such as, for example, the exhaust camshaft 122 and the intake camshaft 124 through the oil hole of the cylinder head 120.

That is, the cylinder head 120 is provided with a plurality of passages divergently extending from the oil hole toward the exhaust camshaft 122, the intake camshaft 124, and the like of the cylinder head 120. The lubricant A2 is fed to the cylinder head 120 through the passages.

The lubricant A2 is collected in the head-side oil pan 20 after being fed to the cylinder head 120.

That is, the cylinder head 120 is provided with an oil outlet port (not shown) serving as a passage that extends from below the exhaust camshaft 122, the intake camshaft 124, and the like, toward the head-side oil pan 20 and communicates with the head-side oil pan 20. The lubricant A2 is collected in the head-side oil pan 20 through the oil outlet port.

As shown in FIGS. 1 and 2, the lubricant A2 pumped by the head-side oil pump 22 is also branched and fed to members disposed in the supercharger 130, such as, for example, the two bearings 136 and 138 supporting the turbine shaft 134 in the housing 132, through the oil hole of the cylinder head 120.

That is, the cylinder head 120 is provided with a passage (not shown) divergently extending from the oil hole toward the supercharger 130. The housing 132 of the supercharger 130 is provided with a passage (not shown) that communicates with the passage of the cylinder head 120 and divergently extends toward the bearings 136 and 138, and the like. The lubricant A2 is fed to the supercharger 130 through each of the passages (see arrows A2 shown in the upper portion of FIG. 2).

The lubricant A2 is collected in the head-side oil pan 20 after being fed to the supercharger 130.

That is, the supercharger 130 is provided with an oil outlet port (not shown) serving as a passage that extends from below the bearings 136 and 138, and the like, toward the head-side oil pan 20 and is open above the head-side oil pan 20. The lubricant A2 is collected in the head-side oil pan 20 through the oil outlet port (see arrow A2 shown in the lower portion of FIG. 2).

The head-side oil passage 24 is a path of the lubricant A2, through which the lubricant A2 is fed from the head-side oil pan 20 to the cylinder head 120 and the supercharger 130 and is then collected in the head-side oil pan 20.

In other words, the head-side oil passage 24 according to the embodiment includes the pipe connecting the head-side oil pump 22 and the cylinder head 120, the oil hole of the cylinder head 120, the passages of the cylinder head 120 and the supercharger 130, the oil outlet port, and the like.

In this manner, the head-side oil passage 24 according to the embodiment serves as a second oil passage for feeding the lubricant A2 to the supercharger 130.

The head-side oil pan 20 according to the embodiment serves as a second oil pan that is disposed in the path of the head-side oil passage 24 and stores the lubricant A2 flowing through the head-side oil passage 24.

The head-side oil pan 20 according to the embodiment is disposed below the supercharger 130.

As such, the lubricant feed mechanism 1 causes the lubricant A2 that has lubricated the bearings 136 and 138, and the like of the supercharger 130 to be simply dropped by its own weight and, thus, the lubricant A2 can be returned to the head-side oil pan 20.

Therefore, the lubricant feed mechanism 1 can collect the lubricant A2 efficiently (without pumping the lubricant A2 to the head-side oil pan 20 using another pump or the like).

Here, feeding the lubricant A1 to the cylinder block 110 will cause the lubricant A1 to contain excessive sludge.

Accordingly, the lubricant feed mechanism 1 according to the embodiment is configured to separately feed the lubricants A1 and A2 of the two oil pans 10 and 20 through two independent oil passages 14 and 24, respectively, rather than branching a single oil passage and feeding lubricant in a single oil pan to the cylinder block 110 and the supercharger 130.

In other words, the lubricant feed mechanism 1 according to the embodiment has two separate passages for lubricant so that the lubricant A1 fed to the cylinder block 110 is not fed to the supercharger 130.

This causes the lubricant feed mechanism 1 to feed the lubricant A1 containing excessive sludge only to the cylinder block 110. That is, the lubricant feed mechanism 1 can feed the lubricant A2 containing less sludge to the supercharger 130.

Therefore, the lubricant feed mechanism 1 can effectively lubricate the bearings 136 and 138 supporting the turbine shaft 134 of the supercharger 130 and prevent or reduce coking in the bearings 136 and 138.

Accordingly, the lubricant feed mechanism 1 can improve resistance to oxidative degradation of the lubricant A2 fed to the supercharger 130.

That is, the lubricant feed mechanism 1 can improve the mechanical efficiency of the supercharger 130.

In this manner, the block-side oil passage 14 and the head-side oil passage 24 are configured to be independent of each other in the lubricant feed mechanism 1.

As described above, the head-side oil pump 22 according to the embodiment is disposed in a state of being immersed in the lubricant A2 stored in the head-side oil pan 20.

This allows the lubricant feed mechanism 1 to warm the lubricant A2 in the head-side oil pan 20 using the heat generated by the head-side oil pump 22, for example, when driving an engine in a low temperature environment.

Therefore, the lubricant feed mechanism 1 can lower the viscosity of the lubricant A2 promptly even in the low temperature environment, and thus the friction of the supercharger 130 can be reduced.

The oil pump according to the present invention (i.e., the head-side oil pump 22 according to the embodiment) only needs to be immersed in the lubricant stored in the second oil pan to the extent that air in the second oil pan (i.e., the head-side oil pan 20 according to the embodiment) is not sucked during operation.

In other words, the phrase “immersed in the lubricant A2” as used in the embodiment refers to a condition in which a suction port of the head-side oil pump 22 is immersed in the lubricant A2 during operation of the head-side oil pump 22. Accordingly, the entire head-side oil pump 22 does not have to be necessarily immersed in the lubricant A2 of the head-side oil pan 20 during operation. For example, an upper end of the head-side oil pump 22 may protrude from the surface of the lubricant during operation.

The lubricant feed mechanism 1 includes an electrically driven oil pump as the head-side oil pump 22.

This allows the head-side oil pump 22 to pump an amount of the lubricant A2 dependent on an applied voltage.

As such, the head-side oil pump 22 can stably feed the lubricant A2 to the supercharger 130 regardless of a rotational speed of the crankshaft 112, i.e., the operating conditions of the engine. That is, the head-side oil pump 22 can feed, to the supercharger 130, the lubricant A2 that is always adjusted to an appropriate amount.

Thus, the lubricant feed mechanism 1 can reduce the friction of the supercharger 130, so that the mechanical efficiency of the supercharger 130 can be effectively improved.

The lubricant feed mechanism 1 can also cool the head-side oil pump 22 using the lubricant A2 stored in the head-side oil pan 20. Accordingly, the lubricant feed mechanism 1 can improve the cooling efficiency of the head-side oil pump 22.

Additionally, in the lubricant feed mechanism 1, a sealing member for preventing leakage of the lubricant A2 does not have to be attached to the head-side oil pump 22 as compared with a case where the head-side oil pump 22 is located at a position away from the head-side oil pan 20.

That is, the lubricant feed mechanism 1, in which the electrically driven head-side oil pump 22 is disposed in a state of being immersed in the lubricant A2 in the head-side oil pan 20, can not only improve the mechanical efficiency of the supercharger 130 but also achieve a long service life and a reduction in the number of parts of the head-side oil pump 22.

The lubricant feed mechanism 1 according to the embodiment also feeds the lubricant A2 for lubricating the supercharger 130 to the cylinder head 120.

This allows the lubricant feed mechanism 1 to feed the lubricant A2 containing less sludge to the cylinder head 120. As such, the lubricant feed mechanism 1 can effectively lubricate the exhaust camshaft 122, the intake camshaft 124, and the like of the cylinder head 120.

Accordingly, the lubricant feed mechanism 1 can improve resistance to oxidative degradation of the lubricant A2 fed to the cylinder head 120.

In other words, the lubricant feed mechanism 1 can improve the mechanical efficiency of the members (e.g., exhaust camshaft 122 and intake camshaft 124) disposed in the cylinder head 120.

In this manner, the head-side oil passage 24 is provided to feed the lubricant A2 stored in the head-side oil pan 20 to the cylinder head 120 of the engine.

The configuration of the lubricant feed mechanism only needs to be such that an oil passage for lubricant fed to the cylinder block and an oil passage for lubricant fed to the supercharger are isolated from each other, and the configuration is not limited to the embodiment.

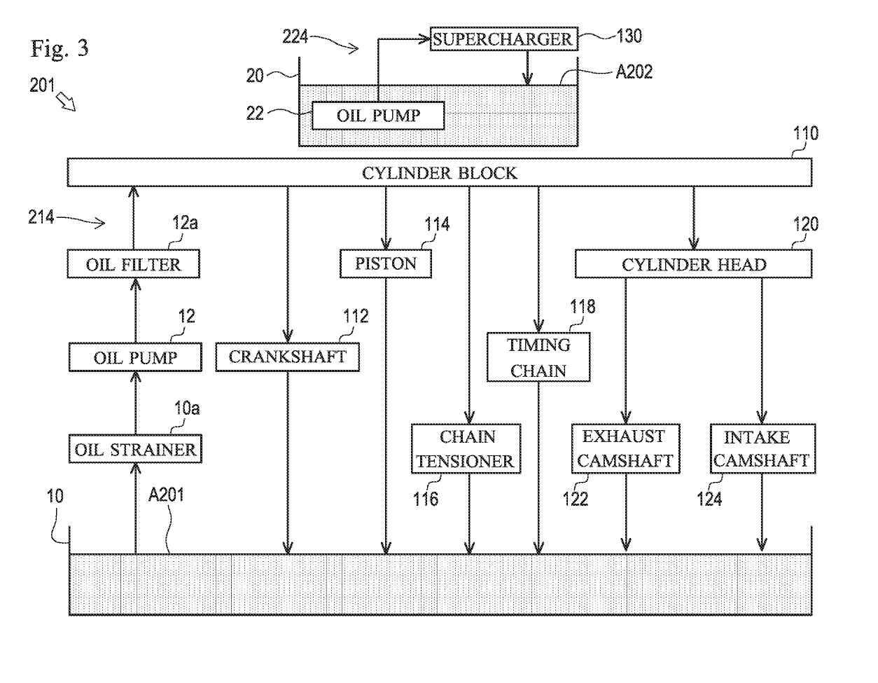

For example, the lubricant feed mechanism can be a lubricant feed mechanism 201 according to another embodiment shown in FIG. 3, which includes a first oil passage 214 for feeding lubricant A201 to a cylinder block 110 and a cylinder head 120 and a second oil passage 224 for feeding lubricant A202 only to a supercharger 130.

### INDUSTRIAL APPLICABILITY

The present invention is applicable to a lubricant feed mechanism for feeding lubricant to an engine and a supercharger mounted on the engine.

### REFERENCE SIGNS LIST

1: Lubricant feed mechanism

10: Block-side oil pan (First oil pan)

14: Block-side oil passage (First oil passage)

20: Head-side oil pan (Second oil pan)

24: Head-side oil passage (Second oil passage)

110: Cylinder block

130: Supercharger

A1: Lubricant (Lubricant flowing through first oil passage)

A2: Lubricant (Lubricant flowing through second oil passage)

1. A lubricant feed mechanism for feeding lubricant to an engine and a supercharger mounted on the engine, the lubricant feed mechanism comprising:
a first oil passage for feeding lubricant to a cylinder block of the engine,
a first oil pan that is disposed in a path of the first oil passage and stores the lubricant flowing through the first oil passage,
a second oil passage for feeding lubricant to the supercharger, and
a second oil pan that is disposed in a path of the second oil passage and stores the lubricant flowing through the second oil passage,
the first oil passage and the second oil passage being configured to be independent of each other.

2. The lubricant feed mechanism according to claim 1, further comprising an electrically driven oil pump that is disposed in a state of being immersed in the lubricant stored in the second oil pan and pumps the lubricant stored in the second oil pan.

3. The lubricant feed mechanism according to claim 1, wherein
the second oil passage is provided to feed the lubricant stored in the second oil pan to a cylinder head of the engine.

4. The lubricant feed mechanism according to claim 1, wherein
the second oil pan is disposed below the supercharger.

5. The lubricant feed mechanism according to claim 2, wherein
the second oil passage is provided to feed the lubricant stored in the second oil pan to a cylinder head of the engine.

6. The lubricant feed mechanism according to claim 2, wherein
the second oil pan is disposed below the supercharger.

7. The lubricant feed mechanism according to claim 3, wherein
the second oil pan is disposed below the supercharger.

8. The lubricant feed mechanism according to claim 5, wherein
the second oil pan is disposed below the supercharger.
